(19) United States
(12) Patent Application Publication
(10) Pub. No.: US 2009/0110261 A1
(43) Pub. Date: Apr. 30, 2009

(54) Apparatus and Method for Verifying Pattern of Semiconductor Device

(75) Inventor: Hyun Jo Yang, Cheongiu-si (KR)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: HYNIX SEMICONDUCTOR INC., Incheon-si (KR)

(21) Appl. No.: 12/133,570

(22) Filed: Jun. 5, 2008

(30) Foreign Application Priority Data
Oct. 31, 2007 (KR) 10-2007-0110680

(51) Int. Cl. G06K 9/00

(52) U.S. Cl. 382/145

(57) ABSTRACT

An apparatus and method for verifying the pattern of a semiconductor device provides for automatically detecting the leaning of pattern by using a design layout and the upper and the lower SEM (Scanning Electron Microscope) image of the pattern formed according to the design layout.

### CROSS-REFERENCE TO RELATED APPLICATION

The priority of Korean patent application number 10-2007-0110680, filed on Oct. 31, 2007, which is incorporated by reference in its entirety, is claimed.

### BACKGROUND OF THE INVENTION

The present invention relates to an apparatus for verifying a pattern of a semiconductor device, which is capable of readily detecting the leaning of a pattern, and a verifying method thereof.

As the integration density of semiconductor devices has increased, the aspect ratio of the semiconductor device has increased more. Therefore, in the case of a line pattern, the phenomenon of leaning is generated due to stress resulting after the last etch process.

FIG. 1 is a picture showing the cross section of a semiconductor device according to the related art and shows the phenomenon of leaning in the line pattern of the semiconductor device. Conventionally, in order to read the leaning, a specified part was cut like the photograph of FIG. 1 to confirm the image with the naked eye. However, it is essentially impossible to detect a defect by cutting a minute semiconductor device one by one. Moreover, the process is destructive of the semiconductor device.

Therefore, conventionally, an additional inspection is not performed for the phenomenon of leaning. However, as the semiconductor device is highly integrated, such leaning phenomenon causes the overall inferiority of the semiconductor device and reduced processing yield.

### BRIEF SUMMARY OF THE INVENTION

Embodiments of the present invention are directed to apparatus and methods to compare the design layout data with the data of a pattern actually formed according to the design layout data in order to detect the leaning of the pattern formed in a semiconductor device.

According to an embodiment of the present invention, a pattern verifying apparatus of a semiconductor device includes a design layout data input unit that receives a design layout data for a pattern; a pattern image measuring unit that obtains a pattern image data by measuring the image of the pattern which is formed according to the design layout data; a comparison determination unit that generates an error data to indicate the extent of leaning of the pattern by using the design layout data and the pattern image data; and a reliability decision unit to determine the reliability of the pattern by comparing the error data with a preset process margin data.

The pattern image measuring unit may measure a SEM (Scanning Electron Microscope) image of the upper portion and the lower portion of the pattern to obtain upper pattern image data and lower pattern image data. The comparison determination unit arranges a lower pattern and a design layout by using the design layout data and the lower pattern image data. The comparison determination unit may arrange the design layout and the lower pattern by using a vector matching. The pattern image measuring unit measures an upper SEM image of the pattern when the design layout and the lower pattern are arranged. The comparison determination unit calculates the error data by calculating an EPE (Edge Placement Error) between the design layout and an upper pattern by using of the design layout data and the upper pattern image data.

According to an embodiment of the present invention, a pattern verifying method of a semiconductor device includes measuring a lower portion image of a pattern; arranging the lower portion image with a design layout of the pattern; measuring an upper portion image of the pattern; and detecting a leaning of the pattern by comparing the design layout with the upper portion image.

The upper and the lower portion image may be SEM (Scanning Electron Microscope) images. Vector matching may arrange the lower portion image with a design layout of the pattern. Measuring of an upper portion image occurs when the design layout and the lower portion image are arranged. Detecting a leaning of the pattern may include calculating a left/right EPE (Edge Placement Error) between the design layout and the lower portion image; and calculating a difference of the left/right EPE. The pattern verifying method of the invention may further includes determining whether the extent of leaning is in the range of a preset process margin or not.

### BRIEF DESCRIPTION OF THE DRAWINGS

FIG. 1 is an illustration showing the cross section of a semiconductor device according to the related art.

FIG. 2 is a block diagram illustration showing the configuration of a pattern verifying apparatus of a semiconductor device according to an embodiment of the present invention.

FIGS. 3 and 4 are a cross sectional view and a plan view for a line pattern formed at an upper portion of a semiconductor substrate.

FIG. 5 is a schematic drawing showing an image where the design layout is overlapped with a measured pattern image.

FIG. 6 is a schematic drawing showing an arrangement of an image of the lower pattern adjusted with the design layout by using vector matching.

FIG. 7 is a schematic drawing showing the comparing a design layout 320 with a lower pattern image.

FIG. 8 is a flowchart illustrating a method of verifying a pattern of a semiconductor device.

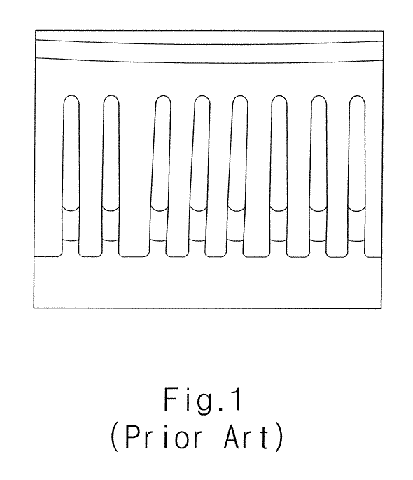

### DESCRIPTION OF EMBODIMENTS

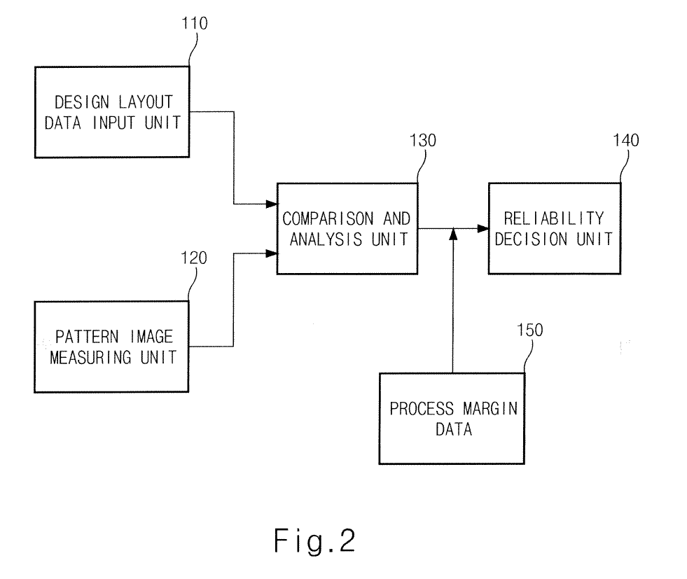

FIG. 2 is a lock diagram showing the configuration of a pattern verifying apparatus of a semiconductor device according to an embodiment of the present invention. The pattern verifying apparatus according to embodiments of the present invention may include a design layout data input unit 110, a pattern image measuring unit 120, a comparison and analysis unit 130, and a reliability decision unit 140.

The design layout data input unit 110 receives design data for a pattern to form in the manufacture process of semiconductor devices. This data may be received from a design data database or other suitable storage device (not depicted). The design layout data input unit 110 has provides a design layout data output to the comparison and analysis unit 130.

The pattern image measuring unit 120 obtains pattern image data by measuring the image of the upper portion and the lower portion of an actually formed pattern, the pattern being formed according to the design layout data at the upper portion of a wafer. The pattern image measuring unit 10 outputs the obtained pattern image data to the comparison and analysis unit 130. The pattern image measuring unit 120 may use existing SEM (Scanning Electron Microscope) image measurement methods to obtain the pattern image measurement. By using the SEM image measurement method, the pattern image measuring unit 120 can measure the lower portion SEM image and the upper portion SEM image of an actual pattern respectively, and obtain pattern image data for each image (lower pattern image data and upper pattern image data).

The comparison and analysis unit 130 calculates an error data which indicates the extent of leaning of the actually formed pattern from the design layout data input unit 110 and the pattern image data from the pattern image measuring unit 120. The comparison and analysis unit 130 may arrange the lower pattern according to the design layout by using the design layout data and the lower pattern image data. Then, the comparison and analysis unit 130 may calculate the extent of the leaning of the actually formed pattern by comparing the design layout and the upper pattern using the design layout data and the upper pattern image data given that the lower pattern is arranged. The comparison and analysis unit 130 may then determine error data of the actually formed pattern from which an error range may be determined.

The reliability decision unit 140 confirms whether the error range is included in the process margin range or not by comparing the error data with preset process margin data 150. Whether the error range is within the process margin range and/or an extent of departure of the error range from the process margin range allows the reliability decision unit 140 to determine a reliability of the device. That is, the reliability decision unit 140 may determine a device from which the data is obtained as inferior in the case that the error range exceeds the process margin range.

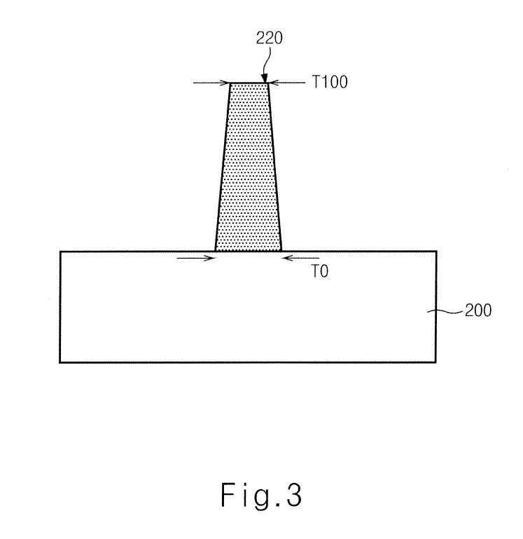

FIGS. 3 to 7 are schematic diagrams showing the principles that measure the leaning of a pattern by using an upper pattern image and a lower pattern image of the pattern.

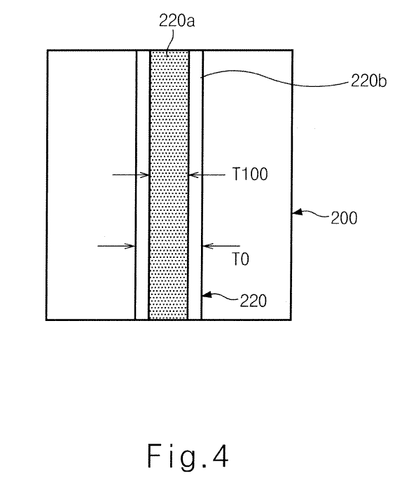

FIGS. 3 and 4 are a cross sectional view and a plane view for a line pattern 220 formed over a semiconductor substrate 200.

In embodiments of the present invention, the upper portion and the lower portion (floor) of a pattern 220 formed over a semiconductor substrate 200 are classified to facilitate measuring each with the SEM to generate image data 220a and 220b. As a exemplary rule, the bottom of the pattern 220 can be measured by setting (T0) a threshold of a SEM image measure apparatus as ‘0’ (the lowest value), while the top of pattern can be measured by setting (T100) a threshold of a SEM image measure apparatus as ‘100’ (the highest value).

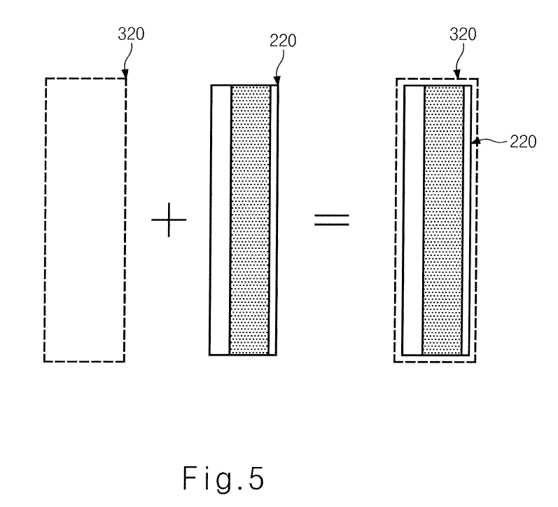

FIG. 5 is a drawing showing an image where a design layout 320 based upon the design data for the pattern is overlapped with the SEM image data of the pattern 220, which is actually formed according to the design layout 320. According to an embodiment of the present invention, leaning of the pattern 220 is determined by comparison of the SEM image data of the pattern 220 with the design layout 320.

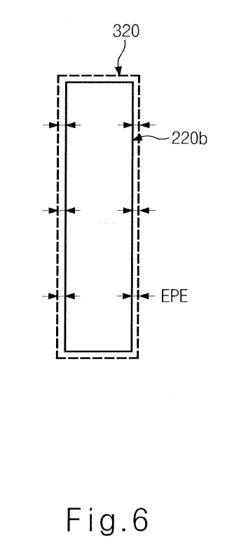

FIG. 6 schematically shows arrangement of SEM image data of the lower pattern adjusted with respect to the design layout. This arrangement of the SEM image data to the design layout may be accomplished by using vector matching or other suitable techniques. For example, using vector matching, the comparison and analysis unit 130 fits the central line of the design layout 320 and the lower pattern image 220b by using the design layout data and the lower pattern image data. Thereafter, the design layout 320 and the lower pattern image 220b are arranged in such a manner that the left/right (or top/bottom) EPE (Edge Placement Error) between the design layout 320 and the lower pattern image 220b becomes the substantially the same.

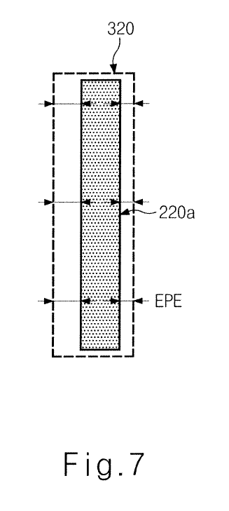

FIG. 7 schematically shows comparing the design layout 320 with a lower pattern image 220b. The upper pattern image 220a is measured in the state where the lower pattern image 220b is arranged as shown in FIG. 6 and described in connection therewith. In order to calculate the extent of leaning of the pattern 220, the comparison and analysis unit 130 may measure the left/right EPE between the design layout 320 and the upper pattern image 220a. That is, in the case that the EPE value of the left/right is within an error range or acceptable value when the left/right EPE between the design layout 320 and the upper pattern image 220a is measured, it means that the pattern is not leaning or is within the acceptable process margin of acceptable leaning, whereas, in case that the EPE value of the left/right is larger than the error range or acceptable value, it means that the pattern is leaning by as much as the difference.

In addition, in FIGS. 6 and 7, the CD of the upper pattern image 220a and the lower pattern image 220b can be obtained when the left/right EPE value is subtracted from the line width of the design layout 320.

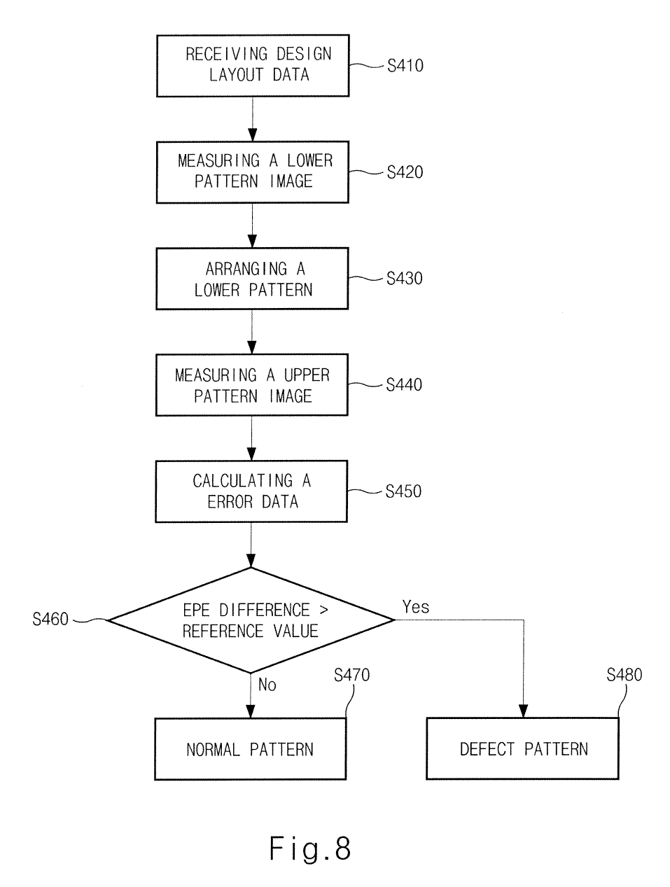

FIG. 8 is a flowchart illustrating a method of verifying a pattern of a semiconductor device, for example by using the pattern verifying apparatus of FIG. 2. The design layout data input unit 110 receives the design layout data designed for the pattern formation, and outputs the data to the comparison and analysis unit 130 (S410). At this time, the design layout data input unit 110, which may include an additional storage means (not shown), receives the design layout data required for the analysis and stores it. Thereafter, it may provide the design layout data according to requests from the comparison and analysis unit 130.

Then, when the pattern 220 is formed over the wafer by using a mask to which the design layout data is applied, the pattern image measuring unit 120 measures the SEM image for the lower portion of the pattern 220 by using the SEM image measurement method, and obtains the lower pattern image data (S420). The operation of the pattern image measuring unit 120 may be manually made according to the indication of user, or can be programmed in order to be automatically performed after the pattern is formed according to each pattern formation process.

The obtained lower pattern image data may then be outputted to the comparison and analysis unit 130. As shown in FIG. 6, the comparison and analysis unit 130 arranges the design layout 320 and the lower pattern image 220b by using the design layout data from the design layout data input unit 110 and the lower pattern image data from the pattern image measuring unit 120 (S430).

If the arrangement is completed, the comparison and analysis unit 130 requests the pattern image measuring unit 120 to measure the upper SEM image of the pattern 220. Accordingly, the pattern image measuring unit 120 measures the upper SEM image of the pattern 220 and obtains the upper pattern image data (S440).

As shown in FIG. 7, the comparison and analysis unit 130 calculates the error data by comparing the design layout 320 with the upper pattern image 220a (S450). For example, after obtaining the left/right EPE between the design layout 320 and the upper pattern image 220a, and calculating the difference, the error data representing the extent of the leaning of the pattern 220 is calculated. The error data calculated like this is transmitted to the reliability decision unit 140.

The reliability decision unit 140 determines whether the extent of leaning deviates from the range of the process margin or not by comparing the error data provided from the comparison and analysis unit 130 with the preset process margin (S460). For example, the reliability decision unit 140 determines whether the difference (error data) of the left/right EPE between the design layout 320 and the upper pattern image 220a is greater than a reference value or not.

As a result of the decision, in case the error data is smaller than the reference value, that is, the leaning of pattern is within the process margin range, the reliability decision unit 140 determines a corresponding pattern as a normal pattern (S470). However, in case the error data is greater than the reference value, that is, the leaning of pattern exceeds the process margin range, the reliability decision unit 140 determines the corresponding pattern as a defect pattern (S480).

Pattern verification in accordance with embodiments of the invention can be performed during the semiconductor device formation at each process for forming pattern.

As described above, the present invention automatically verifies whether the pattern is properly formed within the process margin range or not, by measuring the image of the pattern which is actually formed according to the design layout data, so that the pattern formation result can be exactly and readily verified.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A pattern verifying apparatus of a semiconductor device, comprising:
a design layout data input unit that receives design layout data for a pattern;
a pattern image measuring unit that obtains pattern image data by measuring the image of the pattern formed according to the design layout data;
a comparison determination unit that generates an error data which indicates the extent of leaning of the pattern by using the design layout data and the pattern image data; and
a reliability decision unit that determines the reliability of the pattern by comparing the error data with preset process margin data.

2. The pattern verifying apparatus of claim 1, wherein the pattern image measuring unit measures a SEM (Scanning Electron Microscope) image of the upper portion and the lower portion of the pattern to obtain an upper pattern image data and a lower pattern image data.

3. The pattern verifying apparatus of claim 2, wherein the comparison determination unit arranges a lower pattern and a design layout by using the design layout data and the lower pattern image data.

4. The pattern verifying apparatus of claim 3, wherein the comparison determination unit arranges the design layout and the lower pattern by using vector matching.

5. The pattern verifying apparatus of claim 3, wherein the pattern image measuring unit measures an upper SEM image of the pattern when the arranged design layout and lower pattern.

6. The pattern verifying apparatus of claim 5, wherein the comparison determination unit calculates the error data by calculating an EPE (Edge Placement Error) between the design layout and an upper pattern by using the design layout data and the upper pattern image data.

7. A pattern verifying method of a semiconductor device, comprising:
measuring a lower portion image of a pattern;
arranging the lower portion image with a design layout of the pattern;
measuring an upper portion image of the pattern; and
detecting a leaning of the pattern by comparing the design layout with the upper portion image.

8. The pattern verifying method of claim 7, wherein each of measuring a lower portion image and an upper portion image of the patter comprising SEM (Scanning Electron Microscope) imaging.

9. The pattern verifying method of claim 7, wherein arranging the lower portion image with a design layout of the pattern comprises vector matching the lower portion image and the design layout.

10. The pattern verifying method of claim 7, wherein measuring an upper portion image follows arranging of the design layout and the lower portion image.

11. The pattern verifying method of claim 7, wherein detecting a leaning of the pattern comprises:
calculating a left/right EPE (Edge Placement Error) between the design layout and the upper portion image; and
calculating a difference of the left/right EPE.

12. The pattern verifying method of claim 7, further comprising determining whether the extent of leaning is in the range of a preset process margin or not.
